(19) United States
(12) Patent Application Publication
(10) Pub. No.: US 2004/0237945 A1
(43) Pub. Date: Dec. 2, 2004

(54) Evaporative emissions control and diagnostics module

(76) Inventor: Andre Veinotte, Ontario (CA)

Correspondence Address: MORGAN LEWIS & BOCKIUS LLP, 1111 PENNSYLVANIA AVENUE NW, WASHINGTON, DC, 20004, US

(21) Appl. No.: 10/804,197

(22) Filed: Mar. 19, 2004

Related U.S. Application Data
(60) Provisional application No. 60/456,418, filed on Mar. 21, 2003.
(60) Provisional application No. 60/456,383, filed on Mar. 21, 2003.

(51) Int. Cl. F02M 33/04

(52) U.S. Cl. 123/520

(57) ABSTRACT

A vapor collection canister for an on-board fuel vapor emission control system. The vapor collection canister includes a housing having a first port and a second port. An adsorbent is disposed in the housing. A temperature sensor is exposed to the adsorbent.

### CROSS REFERENCE TO CO-PENDING APPLICATIONS

This application claims the benefit of the earlier filing date of U.S. Provisional Application No. 60/456,418 filed Mar. 21, 2003, and U.S. Provisional Application No. 60/456,383, filed Mar. 21, 2003, the contents of which are incorporated by reference herein in their entirety.

### FIELD OF THE INVENTION

This invention relates generally to on-board emission control systems for internal combustion engine powered motor vehicles, e.g., evaporative emission control systems, and more particularly to a vapor collection canister, such as a charcoal canister, in an evaporative emission control system.

### BACKGROUND OF THE INVENTION

A known on-board evaporative emission control system includes a vapor collection canister that collects fuel vapor emitted from a tank containing a volatile liquid fuel for the engine. During engine operation, vacuum from the engine intake manifold induces atmospheric air flow through the canister to desorb the collected fuel vapor, and draws the fuel vapor into the engine intake manifold for comsumption in the combustion process. A canister purge solenoid valve is under the control of a purge control signal generated by a microprocessor-based engine management system, and periodically purges the collected vapor to the engine intake manifold.

As the vapor collection canister collects fuel vapor, the canister gradually becomes saturated with the fuel vapor. It is believed that there is a need for a method and apparatus for determining the degree of saturation of the canister.

### SUMMARY OF THE INVENTION

In an embodiment, the invention provides a vapor collection canister for an on-board fuel vapor emission control system. The vapor collection canister includes a housing defining a first port and a second port. An adsorbent is disposed in the housing, and a temperature sensor is exposed to the adsorbent.

A plurality of temperature sensors may be disposed in the adsorbent. A flow path may be formed between the first port and the second port. A first one of the plurality of temperature sensors may be disposed near the first port, a second one of the plurality of temperature sensors may be disposed near the second port, and a third one of the the plurality of temperature sensors may be disposed between the first one and the second one. The housing may include a first wall, a second wall and a third wall extending between the first wall and the second wall. A partition wall may include a proximate end, a distal end, and first and second edges and first and second faces extending between the proximate end and the distal end. The proximate end may be mated with the first housing wall, the distal end may be spaced from the second housing wall, and the first and second edges may be mated with the third housing wall. The first port may be disposed on the first housing wall adjacent the first face of the partition wall, and the second port may be disposed on the first housing wall adjacent the second face of the partition wall. The flow path may include a first portion and a second portion, the first portion being defined by the first port, the first face of the partition wall and the third wall of the housing. The second portion may be defined by the second port, the second face of the partition wall and the third wall of the housing.

A first lead frame may be disposed in the first flow path portion and may be mated to the first face of the partition wall, and a second lead frame may be disposed in the second flow path portion and may be mated to the second face of the partition wall. A first one of the plurality of temperature sensors may be disposed on the first lead frame, and a second one of the plurality of temperature sensors may be disposed on the second lead frame. The first one of the plurality of temperature sensors may be disposed proximate the first port, the second one of the plurality of temperature sensors may be disposed proximate the second port, and additional ones of the plurality of temperature sensors may be disposed on the first and second lead frames between the first one and the second one, along the first and second portions of the flow path.

A plurality of sensor leads may be disposed on the first and second lead frames and may be electrically connected to respective ones of the plurality of temperature sensors. The canister may include a connector terminal having a connector terminal power lead, a connector terminal gound lead and a connector terminal signal lead, and a printed circuit board. The power lead, ground lead and signal lead of the connector terminal may be electrically connected to the printed circuit board. Each of the plurality of sensor leads may include a sensor power lead and a sensor signal lead, and each of the plurality of sensor leads may be electrically connected to the printed circuit board. A common ground lead may be electrically connected to each of the plurality of sensors. The plurality of temperature sensors may comprise thermisters.

In another embodiment, the invention provides an on-board fuel vapor emission control system for an internal combustion engine. The system includes a vapor collection canister having a housing defining a first port and a second port, an adsorbent disposed in the housing, and a temperature sensor exposed to the adsorbent. A first conduit provides fluid communication between a fuel tank headspace, the first port of the vapor collection canister, and an intake manifold of the internal combusion engine. A second conduit provides fluid communication between the second port of the vapor collection canister and ambient atmosphere.

A flow path may be formed between the first port and the second port. The temperature sensor may include a plurality of temperature sensors. A first one of the plurality of temperature sensors may be disposed proximate the first port, a second one of the plurality of temperature sensors may be disposed proximate the second port, and a third one of the plurality of temperature sensors may be disposed intermediate the first one and the second one. A plurality of sensor leads may each include a sensor power lead and a sensor signal lead. The plurality of sensor leads may be electrically connected to respective ones of the plurality of temperature sensors. The system may include a printed circuit board. The vapor collection canister may include a connector terminal having a connector terminal power lead, a connector terminal gound lead and a connector terminal signal lead. The power lead, ground lead and signal lead of the connector terminal may be electrically connected to the printed circuit board. Each of the plurality of sensor leads may be electrically connected to the printed circuit board. A common ground lead may be electrically connected to each of the plurality of sensors.

The first conduit may include a solenoid actuated purge valve. The second conduit may include a pressure management valve for managing the pressure in the vapor collection canister and the fuel tank head space. The printed circuit board may be disposed in the pressure management valve. The system may include an electronic control unit. The electronic control unit may be electrically connected to the printed circuit board for receiving a control signal from one of the plurality of temperature sensors, and may be electrically connected to the solenoid actuated purge valve for sending an actuating control signal to the purge valve.

In yet another embodiment, the invention provides a method of measuring the saturation of an adsorbent disposed in a flow-path of a vapor collection canister. The method includes monitoring an adsorption front, and signaling a location of the adsorption front. The monitoring the adsorption front may include measuring a temperature of at-least one portion of the adsorbent. The adsorption front may be located at approximately 25% of the length of the flow-path, approximately 50% of the length of the flow-path, approximately 75% of the length of the flow-path, and approximately 100% of the length of the flow-path.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a schematic illustration of an on-board evaporative emission control system, according to an embodiment of the invention.

FIG. 2 is a cross-sectional view of a vapor collection canister, according to an embodiment of the invention.

FIG. 3 is a cross-sectional view at axis 3-3 of the vapor collection canister of FIG. 2.

FIG. 4a is a schematic illustration of a vapor collection canister, in a condition of 25% fuel vapor saturation, according to an embodiment of the invention.

FIG. 4b is a schematic illustration of a vapor collection canister, in a condition of 50% fuel vapor saturation, according to an embodiment of the invention.

FIG. 4c is a schematic illustration of a vapor collection canister, in a condition of 75% fuel vapor saturation, according to an embodiment of the invention.

FIG. 4d is a schematic illustration of a vapor collection canister, in a condition of 100% fuel vapor saturation, according to an embodiment of the invention.

FIG. 5 is a graphical representation of testing data for a vapor collection canister, according to an embodiment of the invention.

FIG. 6 is another graphical representation of testing data for a vapor collection canister, according to an embodiment of the invention.

### DETAILED DESCRIPTION OF THE PREFERRED EMBODIMENTS

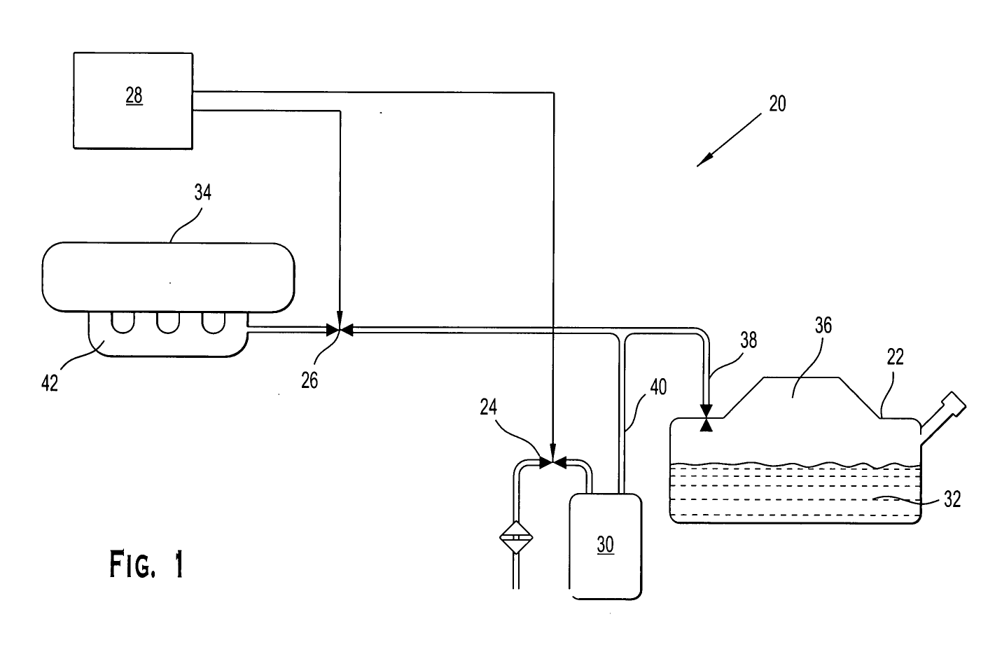

FIG. 1 schematically illustrates a preferred embodiment of an on-board evaporative emission control system 20. In the preferred embodiment, system 20 includes a vapor collection canister 30, a fuel tank 22, an integrated pressure management apparatus 24, a canister purge solenoid valve 26, and a microprocessor-based engine management system 28. Fuel tank 22 contains a volatile liquid fuel 32 for suppyling an internal combustion engine 34. Fuel vapor is emitted from the volatile liquid fuel 32 to a headspace 36 in the fuel tank 22. Conduits 38 and 40 provide a vapor connection between head space 36, vapor collection canister 30, and an intake manifold 42 of the internal combustion engine 34. Canister purge solenoid valve 26 is disposed in conduit 38 between intake manifold 42 and vapor collection canister 30. The integrated pressure management apparatus 24 is preferably integrally mounted on the vapor collection canister 30, and manages the internal pressure of the vapor collection canister 30 and the fuel tank 22. Reference is made to U.S. Pat. No. 6,668,876 for further description of an integrated pressure management apparatus.

As described in more detail below, vapor collection canister 30 collects fuel vapor emitted from the headspace 36. The amount of fuel vapor formed in headspace 36 is a function of vehicle dynamics, slosh, temperature, the type and grade of the volatile liquid fuel 32 in tank 22, and the pressure in tank 22. During operation of engine 34, vacuum from the engine intake manifold 42 acts on the canister purge solenoid valve 26. The canister purge solenoid valve 26 is under the control of a purge control signal generated by the microprocessor-based engine management system 28, and periodically purges the collected vapor to the engine intake manifold. With canister purge solenoid valve 26 in an open configuration, vacuum induces atmospheric air flow through the vapor collection canister 30 to desorb the collected fuel vapor from the canister 30, and draw the fuel vapor into the engine intake manifold 42 for comsumption in the combustion process.

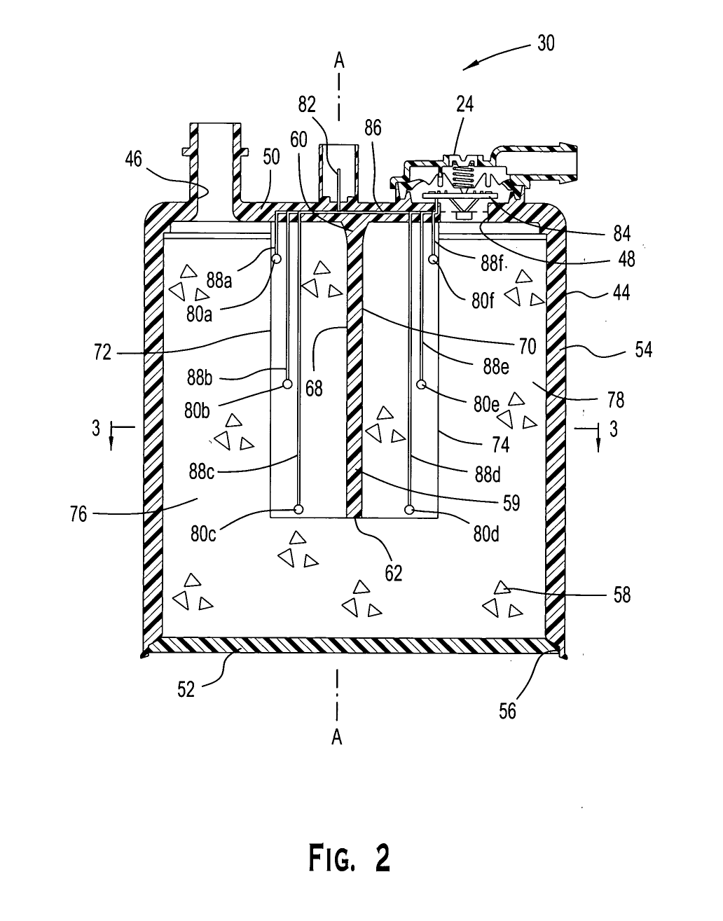

FIG. 2 is a cross-sectional view of the vapor collection canister 30. Vapor collection canister 30 includes a housing 44 having a first port 46 and a second port 48. Housing 44 includes a first wall 50, a second wall 52, and a third wall 54 extending between first wall 50 and second wall 52. As shown in FIG. 2, third wall 54 is integrally formed with first wall 50, and second wall 52 forms a connection with third wall 54 at 56. However, first wall 50, second wall 52 and third wall 54 may be may be formed and joined in other ways, as long as housing 54 forms a chamber to contain an adsorbent 58. For example, second wall 52 may be formed integrally with third wall 54, and first wall 50 may form a connection with third wall 54. Adsorbent 58 may be charcoal or carbon, for example, and is described in more detail below.

A partition wall 59 includes a proximate end 60 and a distal end 62, and a first edge 64, a second edge 66, a first face 68 and a second face 70 extending between proximate end 60 and distal end 62. Proximate end 60 may be mated with housing first wall 50, and may be formed integrally with housing first wall 50. Partition wall 60 extends along a longitudinal axis A-A such that distal end 62 is spaced from housing second wall 52. Referring to FIG. 3, first edge 64 and second edge 66 may be mated with housing third wall 54 and may be formed integrally with housing third wall 54. A first lead frame 72 extends substantially the length of partition wall 60, and projects outward from partition wall first face 68 toward housing third wall 54. A second lead frame 74 extends substantially the length of partition wall 59, and projects outward from partition wall second face 70 toward housing third wall 54.

The housing structure as described above forms a flow path between first port 46 and second port 48 such that a first portion 76 of the flow path is formed by first port 46, partition wall first face 68 and housing third wall 54, and a second portion 78 of the flow path is formed by second port 48, partition wall second face 70 and housing third wall 54. In this manner, flow through the vapor collection canister between first port 46 and second port 48 is forced around partition wall 59, rather than short circuiting in a direct path between first port 46 and second port 48.

The adsorbent 58 substantially fills the first portion 76 and the second portion 78 of the canister flow path. The adsorbent 58 adsorbs fuel vapor that passes through it by the process of adsorption. In one instance, adsorption is the partitioning of matter from a vapor phase onto the surface of a solid. The adsorbing solid is the adsorbent, and the matter concentrated or adsorbed on the surface of that solid is the adsorbate. Van der Waals forces and electrostatic forces between the adsorbate molecules and the atoms that comprise the adsorbent surface cause the adsorption. Energy is released in the form of heat as a result of the phase change of the vapor. This release of energy is known as the heat of adsorption. In the case of vapor collection canister 30, as fuel vapor flows through the first portion 76 and the second portion 78 of the canister flow path, the fuel vapor is adsorbed by adsorbent 58 and heat is generated. Depending upon the temperature and the partial pressure of the adsorbate, a condition is reached when a portion of the adsorbent 58 becomes substantially saturated, or loaded. When a portion of adsorbent 58 becomes loaded, a next portion of the adsorbate 58 adsorbs the fuel vapors, and heat is generated at this next portion of the adsorbate. In this manner, an adsorption front is formed that progresses downstream of the flow path, as upstream portions of the adsorbent 58 become loaded.

The heat of adsorption can be used to determine the canister loading by monitoring the adsorption front using means to determine the temperature of the adsorbent, such as one or more temperature sensors. Referring to FIG. 2, temperature sensors 80a-80c are secured to first lead frame 72 and are disposed in the adsorbent 58 within the first portion 76 of the canister flow path. Temperature sensors 80d-80f are secured to second lead frame 74 and are disposed in the adsorbent 58 within the second portion 78 of the canister flow path. Temperature sensors 80a-80f may be thermisters, for example. A connector terminal 82 is disposed at housing first wall 50 and provides an electrical connection to a printed circuit board 84 with a connector terminal lead 86. Connector terminal lead 86 includes a connector terminal power lead, a connector terminal ground lead, and a connector terminal signal lead. Individual sensor leads 88a-88f provide an electrical connection between printed circuit board 84 and respective temperature sensors 80a-80f. Each individual sensor lead 88a-88f includes a sensor power lead and a sensor signal lead. A common ground lead connects sensors 80a-80f. Printed circuit board 84 may be disposed in the integrated pressure management apparatus 24, and is in electrical communication with the electronic control unit 28 of the on-board evaporative emission control system 20. As shown in FIG. 2, temperature sensors 80a-80f are disposed in the adsorbent 58. However, temperature sensors 80a-80f may be disposed in other ways, as long as temperature sensors 80a-80f can detect the temperature of adsorbent 58. For example, temperature sensors 80a-80f may be formed in housing third wall 54, whether in contiguous contact with adsorbent 58, or not.

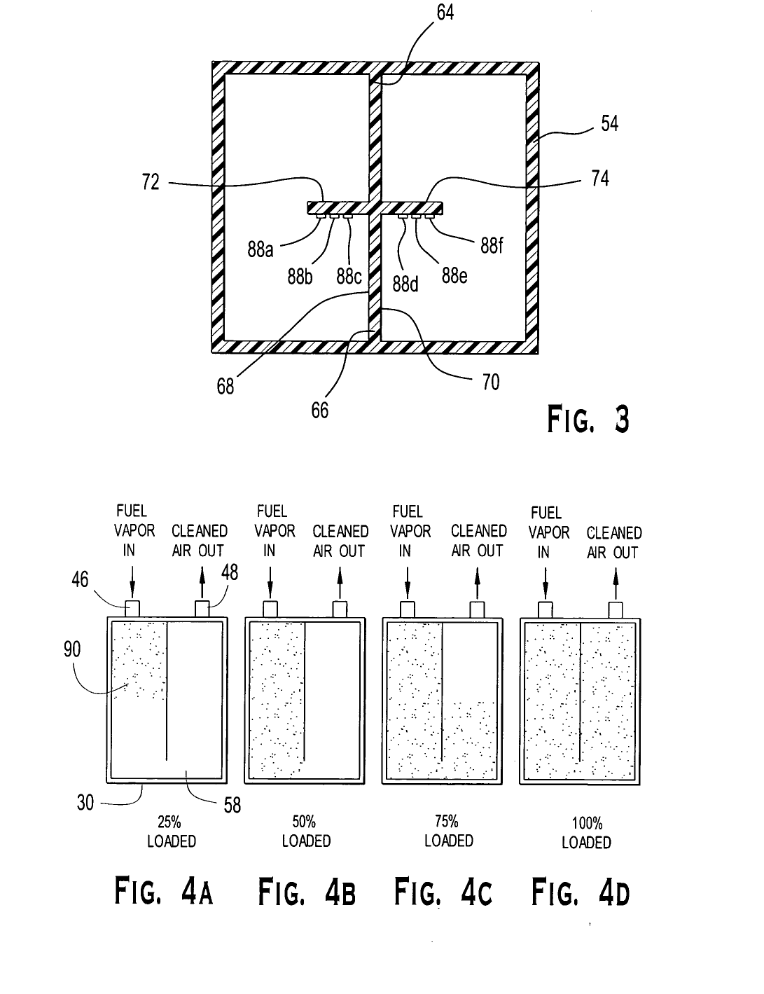

As fuel vapor from fuel tank headspace 36 enters vapor collection canister 30 through first port 46, adsorbent 58 proximate first port 46 adsorbs the fuel vapor. The temperature sensor 80a indicates an elevated temperature because the heat of adsorbtion will be emitted in the vicinity of temperature 80a. As the adsorbent 58 proximate first port 46 becomes saturated, or loaded, the adsorbent 58 proximate first port 46 will not adsorb more fuel vapor, and the adsorption front will progress downstream of the flow path. That is, the fuel vapor will then be adsorbed by adsorbent 58 proximate temperature sensor 80b. Temperature sensor 80b indicates an elevated temperature because the heat of adsorbtion will be emitted in the vicinity of temperature sensor 80b. Thus, it will be known by the instant invention, that the adsorbent proximate first inlet 46 is loaded, because the adsorption of the fuel vapor has progressed downstream of flow path first portion 76 proximate temperature sensor 80b. In this condition, the canister 30 is approximately 25% loaded. FIG. 4a is a schematic illustration of the vapor collection canister 30, showing a condition of 25% fuel vapor saturation, that is 25% of adsorbent 58 is loaded with adsorbate 90. As additional portions of adsorbent 58 become loaded, the adsorption front continues to progress downstream of the flow path past temperature sensors 80c- 80f. FIG. 4b illustrates the vapor collection canister 30 in a 50% loaded condition. FIG. 4c illustrates the vapor collection canister 30 in a 75% loaded condition. When temperature sensor 80f indicates the presence of the adsorbtion front, the adsorbent 58 of the canister 30 is substantially loaded. FIG. 4d illustrates the vapor collection canister 30 in a 100% loaded condition. The printed circuit board 84 can signal the electronic control unit 28, and the electronic control unit 28 can signal the solenoid operated purge valve 26 to open, thus allowing vacuum generated by engine manifold 42 to draw atmospheric air into second port 48, through the canister flow path, out first port 46, and into the engine manifold 42. The flow of atmospheric air through the canister flow path desorbs the adsorbate from the adsorbent 58, and the adsorbate is consumed in the combustion process of the internal combustion engine 34. As a portion of the adsorbent 58 is purged of adsorbate, the temperature of the adsorbent 58 drops, thus defining a desorption front. The drop in temperature can be monitored by temperature sensors 80a-80f. A portion of the adsorbent 58 proximate second port 48 is purged as atmospheric air is drawn through second port 48. Temperature sensor 88f signals a reduced temperature to the printed circuit board 84. The desorption front progresses past temperature sensors 80e-80a. The adsorbent 58 of the canister 30 is substantially purged when temperature sensor 80a signals a drop in temperature, indicating that the desorption front is proximate first port 46. When the canister 30 is substantially purged, the printed circuit board 84 can signal the electronic control unit 28 to actuate the solenoid actuated purge valve 26 to a closed configuration.

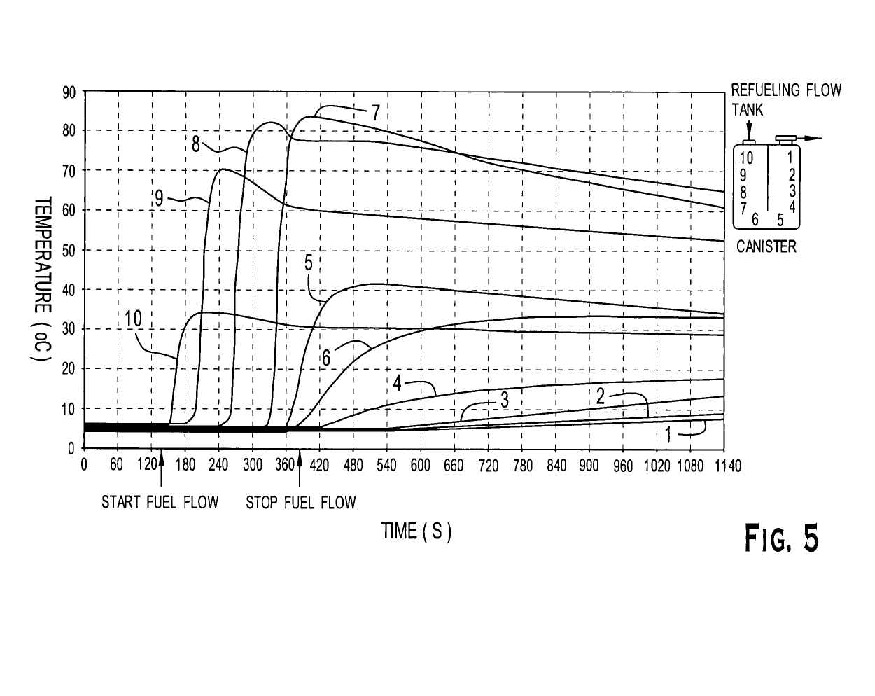

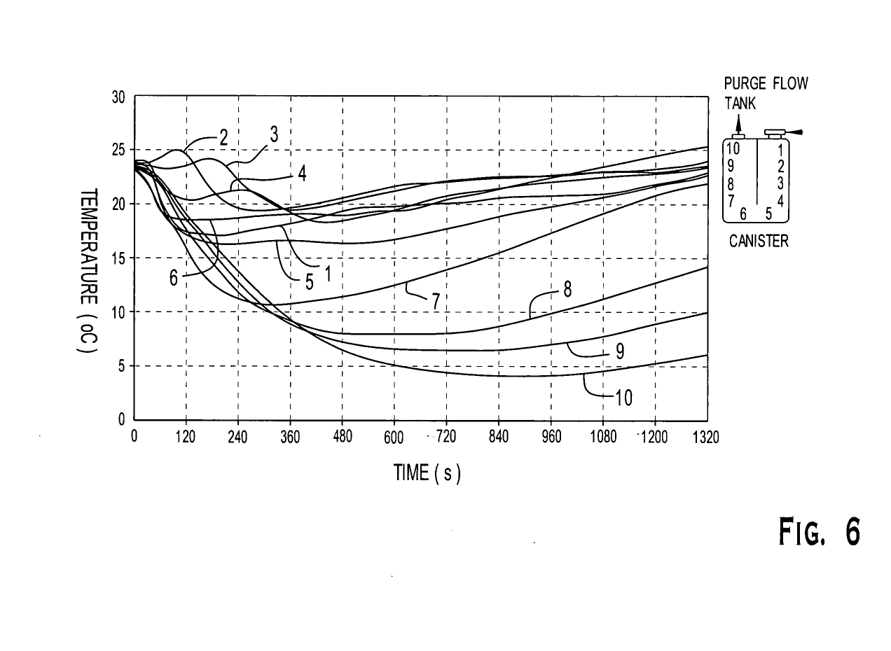

Testing was performed on a preferred embodiment of a vapor collection canister using ten temperature sensors disposed throughout the canister flow path. FIG. 5 illustrates test data captured during a vehicle-refueling event where fuel vapor is being adsorbed by a charcoal canister. As the adsorption front passes each of the temperature sensors embedded in the canister, an increase in temperature is recorded. FIG. 6 illustrates test data captured during a charcoal canister purge event where fuel vapor is being released by the charcoal canister. As the desorbtion front passes each of the temperature sensors embedded in the canister, a decrease in temperature is recorded. The temperature begins to warm up to the ambient temperature after the desorbtion front has passed.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A vapor collection canister for an on-board fuel vapor emission control system, comprising:
a housing defining a first port and a second port;
an adsorbent disposed in the housing; and
at least one temperature sensor exposed to the adsorbent.

2. The vapor collection canister of claim 1, wherein the at least one temperature sensor comprises a plurality of temperature sensors.

3. The vapor collection canister of claim 2, wherein the housing defines a flow path between the first port and the second port.

4. The vapor collection canister of claim 3, wherein a first one of the plurality of temperature sensors is disposed proximate the first port, a second one of the plurality of temperature sensors is disposed proximate the second port, and a third one of the the plurality of temperature sensors is disposed intermediate the first one and the second one.

5. The vapor collection canister of claim 3, wherein the housing comprises a first wall, a second wall and a third wall extending between the first wall and the second wall.

6. The vapor collection canister of claim 5, further comprising a partition wall having a proximate end, a distal end, and first and second edges and first and second faces extending between the proximate end and the distal end, the proximate end being mated with the the first housing wall, the distal end being spaced from the second housing wall, and the first and second edges being mated with the third housing wall.

7. The vapor collection canister of claim 6,
wherein the first port is disposed on the first housing wall adjacent the partition wall first face, the second port is disposed on the first housing wall adjacent the partition wall second face, and
wherein the flow path includes a first portion and a second portion, the portion being defined by the first port, the partition wall first face and the third housing wall, and the second portion being defined by the second port, the partition wall second face and the third housing wall.

8. The vapor collection canister of claim 7, further comprising a first lead frame and a second lead frame, the first lead frame being disposed in the first flow path portion and being mated to the partition wall first face, and the second lead frame being disposed in the second flow path portion and being mated to the partition wall second face.

9. The vapor collection canister of claim 8, whererin a first one of the plurality of temperature sensors is disposed on the first lead frame, and a second one of the plurality of temperature sensors is disposed on the second lead frame.

10. The vapor collection canister of claim 9, wherein the first one of the plurality of temperature sensors is disposed proximate the first port, the second one of the plurality of temperature sensors is disposed proximate the second port, and additional ones of the plurality of temperature sensors are disposed on the first and second lead frames intermediate the first one and the second one, along the first and second portions of the flow path.

11. The vapor collection canister of claim 10, further comprising a plurality of sensor leads disposed on the first and second lead frames, the plurality of sensor leads being electrically connected to respective ones of the plurality of temperature sensors.

12. The vapor collection canister of claim 12, further comprising:
a connector terminal including a connector terminal power lead, a connector terminal gound lead and a connector terminal signal lead; and
a printed circuit board,
wherein the power lead, ground lead and signal lead of the connector terminal are electrically connected to the printed circuit board,
wherein each of the plurality of sensor leads includes a sensor power lead and a sensor signal lead, each of the plurality of sensor leads being electrically connected to the printed circuit board, and
wherein a common ground lead is electrically connected to each of the plurality of sensors.

13. The vapor collection canister of claim 12, wherein the plurality of temperature sensors comprises thermisters.

14. An on-board fuel vapor emission control system for an internal combustion engine comprising:
a vapor collection canister, the vapor collection canister including a housing defining a first port and a second port, an adsorbent disposed in the housing, and at least one temperature sensor exposed to the adsorbent;
a first conduit providing fluid communication between a fuel tank headspace, the first port of the vapor collection canister, and an intake manifold of the internal combusion engine; and
a second conduit providing fluid communication between the second port of the vapor collection canister and ambient atmosphere.

15. The on-board fuel vapor emission control system of claim 14, further comprising a flow path between the first port and the second port,
wherein the at least one temperature sensor comprises a plurality of temperature sensors, a first one of the plurality of temperature sensors being disposed proximate the first port, a second one of the plurality of temperature sensors being disposed proximate the second port, and a third one of the plurality of temperature sensors being disposed intermediate the first one and the second one.

16. The on-board fuel vapor emission control system of claim 15, further comprising a plurality of sensor leads, each of the plurality of sensor leads including a sensor power lead and a sensor signal lead, the plurality of sensor leads being electrically connected to respective ones of the plurality of temperature sensors.

17. The on-board fuel vapor emission control system of claim 16, further comprising a printed circuit board,
wherein the vapor collection canister includes a connector terminal having a connector terminal power lead, a connector terminal gound lead and a connector terminal signal lead, the power lead, ground lead and signal lead of the connector terminal being electrically connected to the printed circuit board,
wherein each of the plurality of sensor leads is electrically connected to the printed circuit board, and
wherein a common ground lead is electrically connected to each of the plurality of sensors.

18. The on-board fuel vapor emission control system of claim 17,
wherein the first conduit comprises a solenoid actuated purge valve, and
wherein the second conduit comprises a pressure management valve for managing the pressure in the vapor collection canister and the fuel tank head space, the printed circuit board being disposed in the pressure management valve.

19. The on-board fuel vapor emission control system of claim 18, further comprising an electronic control unit, the electronic control unit being electrically connected to the printed circuit board for receiving a control signal from one of the plurality of temperature sensors, and being electrically connected to the solenoid actuated purge valve for sending an actuating control signal to the purge valve.

20. A method of measuring the saturation of an adsorbent disposed in a flow-path of a vapor collection canister, comprising:
monitoring an adsorption front; and
signaling a location of the adsorption front.

21. The method of claim 21, wherein the monitoring the adsorption front comprises measuring a temperature of at-least one portion of the adsorbent.

22. The method of claim 21, wherein the adsorption front is located at approximately 25% of the length of the flow-path.

23. The method of claim 21, wherein the adsorption front is located at approximately 50% of the length of the flow-path.

24. The method of claim 21, wherein the adsorption front is located at approximately 75% of the length of the flow-path.

25. The method of claim 21, wherein the adsorption front is located at approximately 100% of the length of the flow-path.
